(19) United States
(12) Patent Application Publication
(10) Pub. No.: US 2026/0118292 A1
(43) Pub. Date: Apr. 30, 2026

(54) SAMPLE POUCH CELL AND X-RAY FLUORESCENCE ANALYSIS METHOD

(71) Applicant: Rigaku Corporation, Akishima-shi, Tokyo (JP)

(72) Inventors: Hikari TAKAHARA, Takatsuki-shi, Osaka (JP); Takashi SHOJI, Takatsuki-shi, Osaka (JP)

(21) Appl. No.: 19/470,737

(22) PCT Filed: Jan. 18, 2024
(86) PCT No.: PCT/JP2024/001226

§ 371 Date: Sep. 29, 2025

(30) Foreign Application Priority Data
Mar. 31, 2023 (JP) 2023-057902

(51) Int. Cl. G01N 23/2204; G01N 1/10; G01N 23/223

(52) U.S. Cl. CPC G01N 23/2204; G01N 1/10; G01N 23/223; G01N 2223/307; G01N 2223/317; G01N 2223/623; G01N 2223/637

(57) ABSTRACT

Provided are an X-ray fluorescence analysis method and a sample pouch cell that enable measurement of a liquid sample, and radiation of X-rays while avoiding air bubbles formed during measurement. The sample pouch cell is a sample pouch cell for a liquid sample, which is to be arranged upright in a side-irradiation type X-ray fluorescence spectrometer. The sample pouch cell includes: a first resin film, which is arranged on a side to which primary X-rays are radiated; and a second resin film bonded to the first resin film in a region excluding an inlet for the liquid sample.

### TECHNICAL FIELD

The present invention relates to a sample pouch cell and an X-ray fluorescence analysis method.

### BACKGROUND ART

There has been known an X-ray fluorescence spectrometer as an apparatus for measuring an element contained in a sample, or a concentration of the element. The X-ray fluorescence spectrometer can perform an analysis even when a sample to be analyzed is a liquid. As methods of measuring a liquid sample, there are known a direct method in which a liquid sample is directly irradiated with X-rays, and a drop method in which a sample dried on a filter is irradiated with X-rays (see Non Patent Literature 1 listed below).

When the direct method is used, a container is used to hold the liquid sample. For example, in Patent Literature 1 listed below, there is disclosed a liquid sample container that is used for a tube-below optics X-ray fluorescence spectrometer. Further, in Patent Literatures 2 to 4 listed below, there are disclosed liquid sample containers that are used for a tube-above optics X-ray fluorescence spectrometer. In Patent Literature 5 listed below, there is disclosed a drop-drying filter paper that is used in the drop method.

### PATENT LITERATURE

[PTL 1] JP 2524760 Y2

[PTL 2] JP 2005-345442 A

[PTL 3] JP 7-5047 U

[PTL 4] JP 2018-205290 A

[PTL 5] JP 62-019967 U

### NON PATENT LITERATURE

[NPL 1] Izumi Nakai, “Actual X-ray Fluorescence Analysis” (2nd edition), Asakura Publishing Co., Ltd., published on Jul. 10, 2016, pages 85-86

### SUMMARY OF INVENTION

### Technical Problem

The drop method is not suitable for measurement of a sample with large matrix effects or a non-volatile sample because of a risk of volatilization of an element contained in the sample. Further, when the tube-above optics X-ray fluorescence spectrometer is used, there is a fear of air bubbles being formed at a position at which the sample is irradiated with X-rays during measurement, and the air bubbles hinder irradiation of the liquid sample with primary X-rays. In addition, when the tube-below optics X-ray fluorescence spectrometer is used, there is a fear of a film or other material holding the sample breaking, resulting in damage and contamination inside the X-ray fluorescence spectrometer. Further, the sample is affected by sedimentation of sample components in some cases.

The present disclosure has been made in view of the problems described above, and has an object to provide an X-ray fluorescence analysis method and a sample pouch cell that enable measurement of a liquid sample irrespective of whether the liquid sample is volatile or non-volatile, and enable radiation of X-rays without being affected by air bubbles formed during measurement, or sedimentation components.

### Solution to Problem

(1) A sample pouch cell according to one aspect of the present disclosure is a sample pouch cell for a liquid sample, which is to be arranged upright in a side-irradiation type X-ray fluorescence spectrometer. The sample pouch cell includes: a first resin film, which is arranged on a side to which primary X-rays are radiated; and a second resin film bonded to the first resin film in a region excluding an inlet for the liquid sample.
(2) In the above-mentioned aspect of the present disclosure, the sample pouch cell further includes a frame body, which has a frame-like shape surrounding a position to be irradiated with the primary X-rays, is arranged between the first resin film and the second resin film, and maintains a distance between the first resin film and the second resin film.
(3) In the above-mentioned aspect of the present disclosure, the first resin film includes an analysis window that is formed in a region in which the first resin film overlaps an inside of the frame body in plan view, and allows transmission of the primary X-rays.
(4) In the above-mentioned aspect of the present disclosure, the analysis window is formed on a lower side of a center of the first resin film, and the inlet is provided on an upper side of a center of the sample pouch cell.
(5) In the above-mentioned aspect of the present disclosure, the analysis window has a polyimide film arranged in a hole formed in the first resin film.
(6) In the above-mentioned aspect of the present disclosure, the sample pouch cell further includes an openable and closable fastener that has a linear shape and is provided in a region provided with the inlet.
(7) An X-ray fluorescence analysis method according to one aspect of the present disclosure is an X-ray fluorescence analysis method using a sample pouch cell including a first resin film and a second resin film. The X-ray fluorescence analysis method includes the steps of: pouring a liquid sample through an inlet into a space defined between the first resin film and the second resin film that are bonded to each other in a region excluding the inlet; sealing the first resin film and the second resin film in a region provided with the inlet to complete the sample pouch cell; arranging the sample pouch cell upright in a side-irradiation type X-ray fluorescence spectrometer; and radiating primary X-rays from a side of the sample pouch cell and performing an X-ray fluorescence analysis based on emitted fluorescent X-rays.
(8) In the above-mentioned aspect of the present disclosure, the X-ray fluorescence analysis method further includes the step of arranging, between the first resin film and the second resin film, a frame body, which has a frame-like shape surrounding a position to be irradiated with the primary X-rays, and maintains a distance between the first resin film and the second resin film before completing the sample pouch cell.
(9) In the above-mentioned aspect of the present disclosure, the first resin film includes an analysis window that is formed in a region in which the first resin film overlaps an inside of the frame body in plan view, and allows transmission of the primary X-rays.
(10) In the above-mentioned aspect of the present disclosure, the analysis window has a polyimide film arranged in a hole formed in the first resin film.
(11) In the above-mentioned aspect of the present disclosure, a predetermined distance is defined between a position of a liquid surface of the liquid sample and an upper end of the first resin film.
(12) In the above-mentioned aspect of the present disclosure, the step of performing the X-ray fluorescence analysis includes the steps of: radiating the primary X-rays to a plurality of points of the sample pouch cell, which are different positions in an up-and-down direction, and obtaining a spectrum representing a relationship between an intensity and energy of emitted fluorescent X-rays for each of the plurality of points; and analyzing an element contained in the liquid sample based on the plurality of spectra obtained for the plurality of points, respectively.

### Advantageous Effects of Invention

According to the present disclosure, the liquid sample can be measured irrespective of whether the liquid sample is volatile or non-volatile, and X-rays can be radiated while avoiding air bubbles formed during measurement.

### BRIEF DESCRIPTION OF DRAWINGS

FIG. 1 are a plan view and a bottom view of a sample pouch cell.

FIG. 2 are sectional views of the sample pouch cell.

FIG. 3 is a plan view of the sample pouch cell according to a modification example.

FIG. 4 are sectional views of the sample pouch cell according to the modification example.

FIG. 5 is a flowchart for showing an X-ray fluorescence analysis method using the sample pouch cell.

FIG. 6 is a schematic view for illustrating a side-irradiation type X-ray fluorescence spectrometer in which the sample pouch cell is arranged.

### DESCRIPTION OF EMBODIMENTS

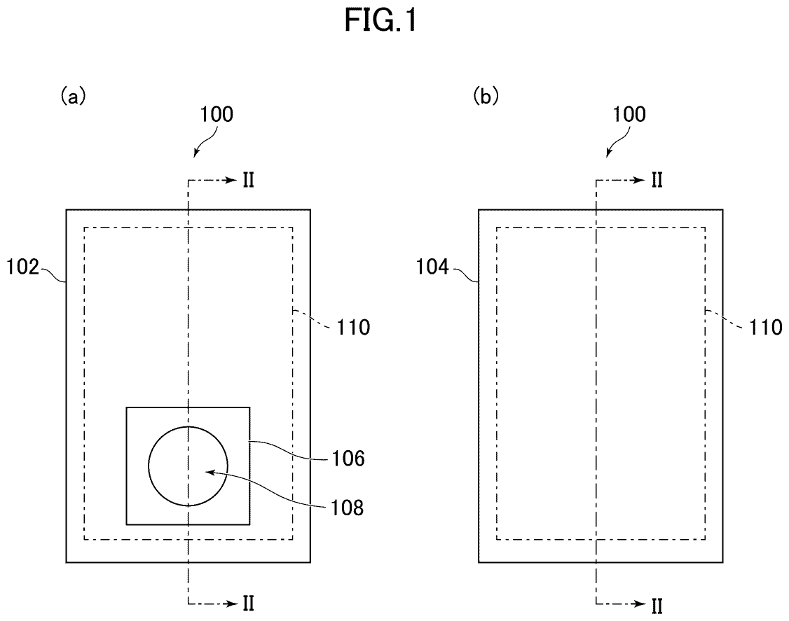

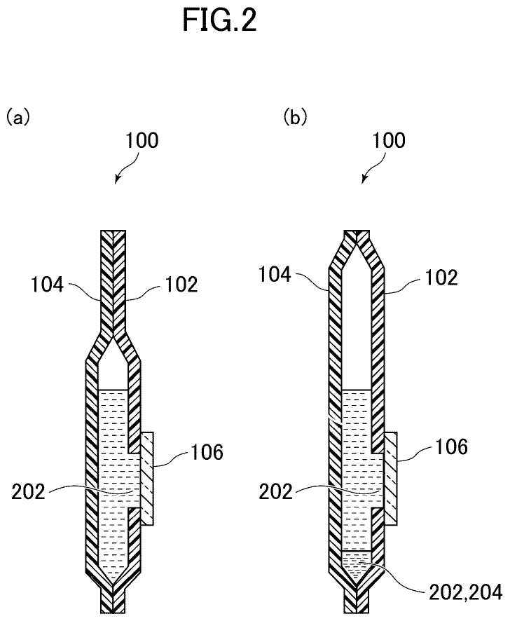

Now, a preferred embodiment for carrying out the present invention (hereinafter referred to as “embodiment”) will be described. FIG. 1(a) is a plan view of a sample pouch cell 100, and FIG. 1(b) is a bottom view of the sample pouch cell 100. FIG. 2(a) and FIG. 2(b) are sectional views taken along the line II-II of FIG. 1(a) and FIG. 1(b). FIG. 2(a) is a view for illustrating the sample pouch cell 100 immediately after the sample pouch cell 100 has been airtightly sealed, and FIG. 2(b) is a view for illustrating the sample pouch cell 100 in a state where air bubbles are formed in a liquid sample 202. The sample pouch cell 100 according to this embodiment is the sample pouch cell 100 to be used in a side-irradiation type X-ray fluorescence spectrometer 600 (described later), and includes a first resin film 102 and a second resin film 104.

The sample pouch cell 100 is the sample pouch cell 100 for the liquid sample 202, which is arranged upright in the side-irradiation type X-ray fluorescence spectrometer 600. The phrase “arranged upright” means that the sample pouch cell 100 is arranged so that a vertical direction, which is a direction of action of gravity, is approximately located in surfaces of the first resin film 102 and the second resin film 104. In other words, the phrase means that a liquid surface of the liquid sample 202 arranged between the first resin film 102 and the second resin film 104 is arranged so as to be approximately orthogonal to the first resin film 102 and the second resin film 104. Further, in the following, an up-and-down direction means a direction that is perpendicular to the liquid surface of the liquid sample 202 (i.e., vertical direction) in a state where the sample pouch cell 100 is arranged in the X-ray fluorescence spectrometer 600. In addition, a downward direction (lower side) is a direction toward a liquid side as seen from the liquid surface when, for example, the liquid surface is used as a reference, and an upward direction (upper side) means a direction opposite to the downward direction.

The first resin film 102 is arranged on a side to which primary X-rays are radiated. Specifically, for example, the first resin film 102 is a film made of a resin such as an aluminum laminate, polypropylene, or polyester. It is desired that the material of the first resin film 102 be a thermoplastic resin.

The first resin film 102 includes an analysis window 108 that is formed on a lower side of a center of the first resin film 102 and allows transmission of the primary X-rays. Specifically, the first resin film 102 has, for example, a rectangular shape, and has a round hole. The round hole is formed so that an upper rim is located on a lower side of the center of the first resin film 102. An extremely thin film 106 made of a resin such as polyimide is arranged over the hole formed in the first resin film 102, and functions as the analysis window 108 during measurement. The shape of the hole that is formed as the analysis window 108 may be a freely-selected shape. Further, it is desired that a predetermined distance be defined between a lower end of the analysis window 108 and a lower end of the first resin film 102. In addition, when the first resin film 102 is made of a material that allows transmission of the primary X-rays, the first resin film 102 is not required to include the analysis window 108.

The second resin film 104 is a resin film that is arranged so as to be opposed to the first resin film 102 through intermediation of the liquid sample 202. Specifically, for example, the second resin film 104 is a film made of the same material as that of the first resin film 102. Unlike the first resin film 102, the second resin film 104 does not have a hole, but it is desired that an external shape of the second resin film 104 conform to the shape of the first resin film 102.

The second resin film 104 is bonded to the first resin film 102. Specifically, the broken lines in FIG. 1(a) and FIG. 1(b) show a region (bonding region 110) in which the first resin film 102 and the second resin film 104 are bonded to each other. The bonding region 110 may be provided at other positions as long as the liquid sample 202 can be held between the first resin film 102 and the second resin film 104. The bonding method is, for example, thermal fusion. When the first resin film 102 and the second resin film 104 are made of a material that is difficult to thermally fuse, the first resin film 102 and the second resin film 104 may be thermally fused together through intermediation of a cord-shaped or tape-shaped thermoplastic resin. Alternatively, the first resin film 102 and the second resin film 104 may be bonded to each other by ultrasonic fusion instead of thermal fusion.

Further, the first resin film 102 and the second resin film 104 may be integrally formed (by a single film). In this case, of the folded single film, a side of the single film to which the primary X-rays are radiated corresponds to the first resin film 102, and the opposite side corresponds to the second resin film 104.

In FIG. 1(a) and FIG. 1(b), there is illustrated the airtightly-sealed sample pouch cell 100 in which the liquid sample 202 is arranged between the first resin film 102 and the second resin film 104. Before the liquid sample 202 is arranged, the first resin film 102 is bonded to the second resin film 104 in a region excluding an inlet for the liquid sample 202. The inlet is provided on an upper side of the center of the sample pouch cell 100. The inlet is provided at, for example, an upper end of the sample pouch cell 100.

Specifically, of the broken lines illustrated in FIG. 1(a) and FIG. 1(b), the lower portion (lower edge of the broken line in FIG. 1(a) ) and the side portions (right and left edges of the broken line in FIG. 1(a) ) are bonded, whereas the upper portion (upper edge of the broken line in FIG. 1(a) ) is not bonded and Serves as the inlet. The liquid sample 202 is poured into the sample pouch cell 100 through the inlet so that a position of the liquid surface is above an upper end of the analysis window 108, and so that a predetermined distance is defined between the position of the liquid surface and an upper end of the first resin film 102. The predetermined distance is set as appropriate in accordance with a volume of the air bubbles formed from the liquid sample 202.

When the sample pouch cell 100 is irradiated with the primary X-rays, a temperature of the liquid sample 202 rises, and air bubbles are formed in the liquid sample 202. The sample pouch cell 100 according to this embodiment is arranged in the side-irradiation type X-ray fluorescence spectrometer 600, and hence even when gas is generated in the liquid sample 202, the air bubbles move to a position on an upper side of the upper end of the analysis window 108 (see FIG. 2(a) and FIG. 2(b)). Accordingly, X-rays can be radiated while avoiding the air bubbles formed during measurement.

The analysis window 108 of the sample pouch cell 100 is arranged on a lower side of the center of the first resin film 102, and the predetermined distance is defined between the position of the liquid surface and the upper end of the first resin film 102. With this configuration, a space that allows escape of the air bubbles formed in the sample pouch cell 100 can be maintained. Further, the predetermined distance is defined between the lower end of the analysis window 108 and the lower end of the first resin film 102, and thus a space for holding the sedimented sample can be secured. Accordingly, a liquid-state region of the sample can be irradiated with the primary X-rays.

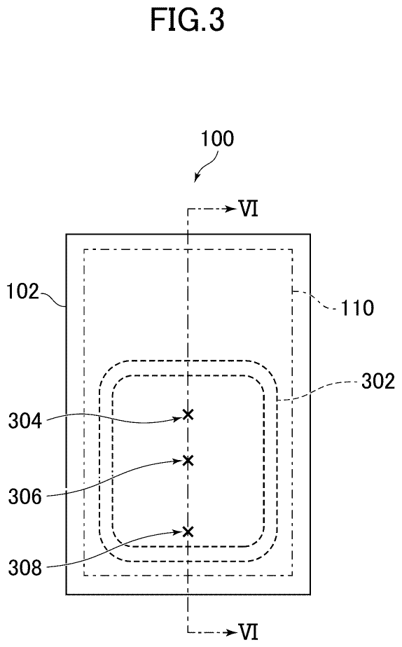

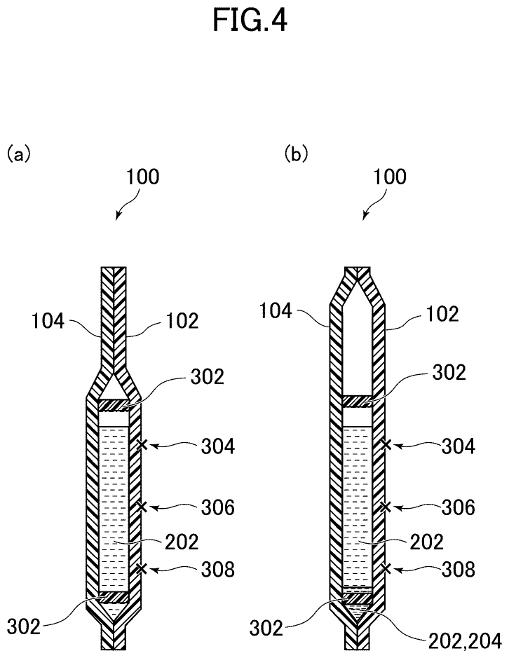

FIG. 3, FIG. 4(a), and FIG. 4(b) are views for illustrating the sample pouch cell 100 according to a modification example of the above-mentioned embodiment. FIG. 3 is a plan view of the sample pouch cell 100. FIG. 4(a) and FIG. 4(b) are sectional views taken along the line VI-VI of FIG. 3. This modification example is different from the above-mentioned embodiment in that there is provided a frame body 302 that maintains a distance between the first resin film 102 and the second resin film 104, and that the first resin film 102 is made of a material allowing transmission of X-rays, and includes no analysis window 108.

The frame body 302 has a frame-like shape surrounding a position to be irradiated with the primary X-rays, and has a predetermined thickness. The frame body 302 is arranged between the first resin film 102 and the second resin film 104, and maintains a distance between the first resin film 102 and the second resin film 104. Specifically, for example, as illustrated in FIG. 3, the frame body 302 is arranged between the first resin film 102 and the second resin film 104 so that irradiation positions 304, 306, and 308 with the primary X-rays are located inside the frame body 302. Further, the frame body 302 has a predetermined thickness, and hence, as illustrated in FIG. 4(a) and FIG. 4(b), a distance corresponding to the thickness of the frame-like shape is defined between the first resin film 102 and the second resin film 104 inside the frame body 302.

In a case in which the frame body 302 is not arranged and the first resin film 102 and the second resin film 104 are bonded to each other, the liquid sample 202 has substantially the same thickness throughout the entire region surrounded by bonding. In this case, a thickness of the region of the sample pouch cell 100 to be irradiated with the primary X-rays is thin, and hence there is a fear of the primary X-rays being transmitted through the second resin film 104, resulting in degradation in analysis accuracy. According to this modification example, by maintaining the thickness with the frame body 302, the thickness of the liquid sample 202 in the region to be irradiated with the primary X-rays can be at least the thickness of the frame body 302. Accordingly, the degradation in analysis accuracy can be avoided.

In this modification example, the first resin film 102 is made of a material allowing transmission of X-rays. Accordingly, in a region of the first resin film 102 in which the liquid sample 202 is present behind the first resin film 102, the primary X-rays can be radiated to a freely-selected position of the first resin film 102, and measurement can be performed.

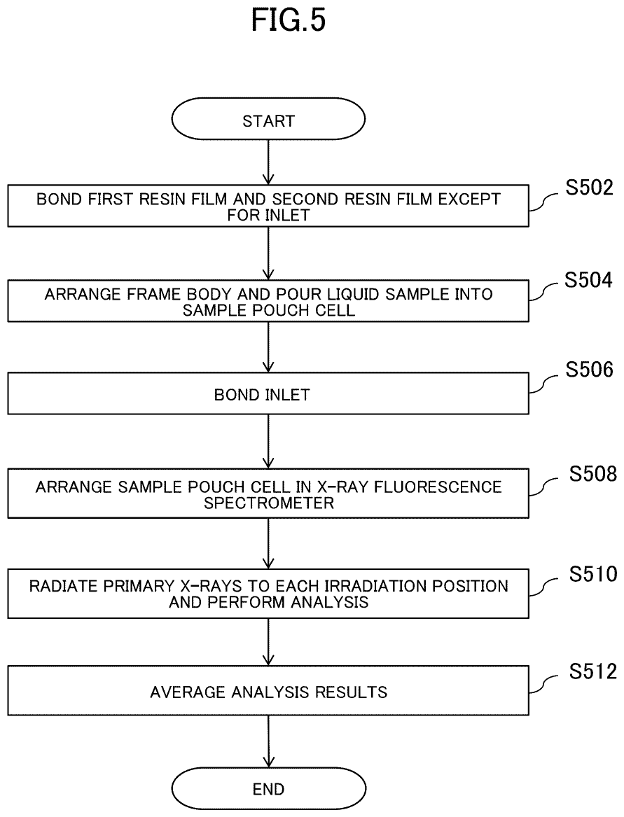

Next, an X-ray fluorescence analysis method using the sample pouch cell 100 will be described. FIG. 5 is a flowchart for illustrating the X-ray fluorescence analysis method using the sample pouch cell 100. First, the first resin film 102 and the second resin film 104 are prepared. Then, in a state where the first resin film 102 and the second resin film 104 are aligned so that positions of outer edges of the first resin film 102 and positions of outer edges of the second resin film 104 match each other, of the bonding region 110, a region excluding the inlet (the lower edge, the left edge, and the right edge of the bonding region 110 illustrated in FIG. 3) is bonded (Step S502).

Next, the frame body 302 is arranged between the first resin film 102 and the second resin film 104, and the liquid sample 202 is poured into the sample pouch cell 100 through the inlet (Step S504). Specifically, the frame body 302 is arranged between the first resin film 102 and the second resin film 104, where the region excluding the inlet is thermally fused. The liquid sample 202 is further poured into the sample pouch cell 100 through the inlet so that the position of the liquid surface is above an upper end of the frame body 302 between the first resin film 102 and the second resin film 104. At this time, the liquid sample 202 is poured into the sample pouch cell 100 so that a predetermined distance is defined between the position of the liquid surface and the upper end of the first resin film 102.

Next, while the air between the first resin film 102 and the second resin film 104 is expelled, the first resin film 102 and the second resin film 104 in the region provided with the inlet are sealed, thereby completing the sample pouch cell 100 (Step S506). Specifically, the first resin film 102 and the second resin film 104 in the region provided with the inlet are thermally fused. FIG. 4(a) is a sectional view for illustrating the sample pouch cell 100 immediately after the sample pouch cell 100 has been airtightly sealed. As illustrated in FIG. 4(a), the air may be present inside the sample pouch cell 100, but it is desired that, while the air is expelled, the sample pouch cell 100 be airtightly sealed so that an amount of air contained inside the sample pouch cell 100 is as small as possible.

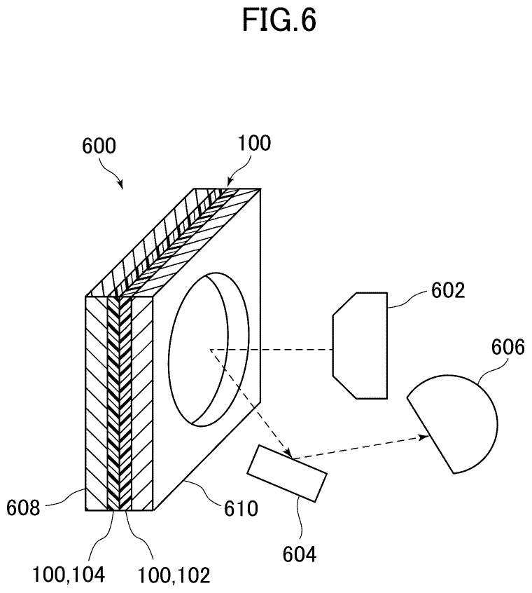

Next, the sample pouch cell 100 is arranged upright in the side-irradiation type X-ray fluorescence spectrometer 600 (Step S508). FIG. 6 is a schematic view for illustrating the side-irradiation type X-ray fluorescence spectrometer 600 in which the sample pouch cell 100 is arranged. As illustrated in FIG. 6, the side-irradiation type X-ray fluorescence spectrometer 600 includes an X-ray source 602, a spectroscopic device 604, a detector 606, a backside holder 608, and a frontside holder 610. The sample pouch cell 100 is sandwiched and arranged between the metallic backside holder 608 and the metallic frontside holder 610, and the frontside holder 610 and the backside holder 608 are fixed inside a measurement chamber (not shown). The frontside holder 610 has a hole, and the first irradiation position 304, the second irradiation position 306, and the third irradiation position 308 are exposed through the hole.

The X-ray source 602 radiates the primary X-rays to the sample pouch cell 100 from a side of the sample pouch cell 100, and an X-ray fluorescence analysis is performed based on emitted fluorescent X-rays (Step S510). Specifically, the primary X-rays are radiated to each of a plurality of points of the sample pouch cell 100 that are different positions in the up-and-down direction, and a spectrum representing a relationship between an intensity and energy of the emitted fluorescent X-rays is obtained for each of the plurality of points. First, the X-ray source 602 radiates the primary X-rays to the first irradiation position 304 of the sample pouch cell 100. Air bubbles are formed from the liquid sample 202 that is heated by irradiation with the primary X-rays.

As illustrated in FIG. 4(b), the air bubbles move to a position on an upper side of the analysis window 108, and an upper portion of the sample pouch cell 100 illustrated in FIG. 4(b) bulges compared to that of the sample pouch cell 100 illustrated in FIG. 4(a). Further, when measurement takes a long time, as illustrated in FIG. 4(b), part of the liquid sample 202 settles in some cases, but a sedimented component 204 is present on a lower side of the lower end of the frame body 302. Accordingly, with this sample pouch cell 100, the primary X-rays can be radiated to the liquid-state region without being hindered by the air bubbles or the sedimented component 204. Fluorescent X-rays are emitted from the liquid sample 202 irradiated with the primary X-rays.

The spectroscopic device 604 spectrally disperses fluorescent X-rays. Specifically, for example, the spectroscopic device 604 spectrally disperses fluorescent X-rays having a specific wavelength that satisfies Bragg's conditional expression among fluorescent X-rays having a plurality of wavelengths, which have been emitted from the liquid sample 202.

The detector 606 is, for example, a scintillation counter. The detector 606 measures an intensity of the fluorescent X-rays and outputs a pulse signal having a pulse height corresponding to measured energy of the fluorescent X-rays.

The spectroscopic device 604 and the detector 606 are pivoted by the goniometer (not shown) while maintaining a fixed angular relationship therebetween. Specifically, for example, θ represents an incident angle formed by a direction in which the fluorescent X-rays emitted from the liquid sample 202 travel and a surface of the spectroscopic device 604. The spectroscopic device 604 is pivoted by the goniometer so that the incident angle θ of the fluorescent X-rays with respect to the surface of the spectroscopic device 604 is varied within a predetermined range. Secondary X-rays are diffracted by the spectroscopic device 604, and the fluorescent X-rays that satisfy the Bragg's conditional expression (i.e., fluorescent X-rays emitted at an emission angle θ) are emitted from the spectroscopic device 604. The detector 606 is moved by the goniometer to a position at which the fluorescent X-rays emitted from the spectroscopic device 604 at the emission angle θ are incident thereon.

By counting pulse signals output from the detector 606 based on a pulse height, the side-irradiation type X-ray fluorescence spectrometer 600 obtains the spectrum representing the relationship between the intensity and energy of the fluorescent X-rays. Based on the spectrum, an element contained in the liquid sample 202 is analyzed. When only a specific element is analyzed, the side-irradiation type X-ray fluorescence spectrometer 600 is not required to include a goniometer, and positions of the spectroscopic device 604 and the detector 606 may be fixed.

As described above, analysis results of the liquid sample 202 are obtained based on the fluorescent X-rays emitted from the first irradiation position 304. Similarly, the X-ray source 602 radiates the primary X-rays to the second irradiation position 306 and the third irradiation position 308, and the spectrum is obtained for each of the positions based on the emitted fluorescent X-rays, thereby performing the X-ray fluorescence analysis.

Final analysis results of an element contained in the liquid sample 202 are obtained by averaging the analysis results at the first irradiation position 304, the second irradiation position 306, and the third irradiation position 308 (Step S512). The case where three measurements are performed has been described above, but the number of measurements is freely selected. Further, weighted average processing (for example, average processing in which a larger weight is given to analysis results of measurement points closer to the center) may be performed instead of simple average processing. The final analysis results are obtained based on the analysis results of a plurality of points, and thus average results can be obtained even when the liquid sample 202 is heterogeneous.

In FIG. 3, there are illustrated the first irradiation position 304, the second irradiation position 306, and the third irradiation position 308, that are different positions in the up-and-down direction. When the analysis results of any one of the measurement points are affected by the air bubbles or sedimentation, there is a possibility that the analysis results of the measurement point will significantly differ from the analysis results of other measurement points. In such cases, the analysis results affected by the air bubbles or sedimentation may be excluded, and the final analysis results may be obtained based on the analysis results of other measurement points.

The present disclosure is not limited to the above-mentioned embodiment and modification example, and various modifications can be made. For example, the region to be provided with the inlet is not required to be bonded, and an openable and closable fastener having a linear shape may be provided in the region. Specifically, a rail fastener may be provided in the region to be provided with the inlet. When an openable and closable fastener is provided, the liquid sample 202 can be easily replaced.

Further, the case in which the X-ray fluorescence spectrometer 600 is a wavelength-dispersive X-ray fluorescence spectrometer has been described above. However, the X-ray fluorescence spectrometer 600 may be an energy-dispersive X-ray fluorescence spectrometer.

In addition, a configuration in which the analysis window 108 is provided, and a configuration in which the frame body 302 is arranged, may be combined with each other. In this case, it is desired that the first resin film 102 include an analysis window that is formed in a region in which the first resin film 102 overlaps the inside of the frame body 302 in plan view, and allows transmission of the primary X-rays. That is, it is desired that the entire analysis window 108 illustrated in FIG. 1 be arranged inside the broken lines representing the frame body illustrated in FIG. 3. Further, in the X-ray fluorescence analysis method illustrated in FIG. 5, the frame body 302 is arranged in the process of Step S504 so that the inside of the frame body 302 and the analysis window 108 overlap each other in plan view.

### REFERENCE SIGNS LIST

100 sample pouch cell, 102 first resin film, 104 second resin film, 106 film made of resin, 108 analysis window, 110 bonding region, 202 liquid sample, 204 sedimented component, 302 frame body, 304 first irradiation position, 306 second irradiation position, 308 third irradiation position, 600 X-ray fluorescence spectrometer, 602 X-ray source, 604 spectroscopic device, 606 detector, 608 backside holder, 610 frontside holder

1. A sample pouch cell for a liquid sample, which is to be arranged upright in a side-irradiation type X-ray fluorescence spectrometer, the sample pouch cell comprising:
a first resin film, which is arranged on a side to which primary X-rays are radiated;
a second resin film bonded to the first resin film in a region excluding an inlet for the liquid sample.

2. The sample pouch cell according to claim 1, further comprising a frame body, which has a frame-like shape surrounding a position to be irradiated with the primary X-rays, is arranged between the first resin film and the second resin film, and maintains a distance between the first resin film and the second resin film.

3. The sample pouch cell according to claim 2, wherein the first resin film includes an analysis window that is formed in a region in which the first resin film overlaps an inside of the frame body in plan view, and allows transmission of the primary X-rays.

4. The sample pouch cell according to claim 3,
wherein the analysis window is formed on a lower side of a center of the first resin film, and
wherein the inlet is provided on an upper side of a center of the sample pouch cell.

5. The sample pouch cell according to claim 3 or 4, wherein the analysis window has a polyimide film arranged in a hole formed in the first resin film.

6. The sample pouch cell according to any one of claims 1 to 3, further comprising an openable and closable fastener that has a linear shape and is provided in a region provided with the inlet.

7. An X-ray fluorescence analysis method using a sample pouch cell including a first resin film and a second resin film, the X-ray fluorescence analysis method comprising the steps of:
pouring a liquid sample through an inlet into a space defined between the first resin film and the second resin film that are bonded to each other in a region excluding the inlet;
sealing the first resin film and the second resin film in a region provided with the inlet to complete the sample pouch cell;
arranging the sample pouch cell upright in a side-irradiation type X-ray fluorescence spectrometer; and
radiating the primary X-rays from a side of the sample pouch cell and performing an X-ray fluorescence analysis based on emitted fluorescent X-rays.

8. The X-ray fluorescence analysis method according to claim 7, further comprising a step of arranging, between the first resin film and the second resin film, a frame body, which has a frame-like shape surrounding a position to be irradiated with primary X-rays, and maintains a distance between the first resin film and the second resin film before completing the sample pouch cell.

9. The X-ray fluorescence analysis method according to claim 8, wherein the first resin film includes an analysis window that is formed in a region in which the first resin film overlaps an inside of the frame body in plan view, and allows transmission of the primary X-rays.

10. The X-ray fluorescence analysis method according to claim 9, wherein the analysis window has a polyimide film arranged in a hole formed in the first resin film.

11. The X-ray fluorescence analysis method according to any one of claims 7 to 10, wherein a predetermined distance is defined between a position of a liquid surface of the liquid sample and an upper end of the first resin film.

12. The X-ray fluorescence analysis method according to any one of claims 7 to 10, wherein the step of performing the X-ray fluorescence analysis comprises the steps of:
radiating the primary X-rays to a plurality of points of the sample pouch cell, which are different positions in an up-and-down direction, and obtaining a spectrum representing a relationship between an intensity and energy of emitted fluorescent X-rays for each of the plurality of points; and
analyzing an element contained in the liquid sample based on the plurality of spectra obtained for the plurality of points, respectively.
